(19) United States
(12) Patent Application Publication
(10) Pub. No.: US 2022/0130151 A1
(43) Pub. Date: Apr. 28, 2022

(54) SURVEILLANCE SYSTEMS AND METHODS

(71) Applicant: ZHEJIANG XINSHENG ELECTRONIC TECHNOLOGY CO., LTD., Hangzhou (CN)

(72) Inventors: Bingyun LYU, Hangzhou (US); Wei FANG, Hangzhou (CN); Yinchang YANG, Hangzhou (CN)

(73) Assignee: ZHEJIANG XINSHENG ELECTRONIC TECHNOLOGY CO., LTD., Hangzhou (CN)

(21) Appl. No.: 17/646,302

(22) Filed: Dec. 29, 2021

Related U.S. Application Data
(63) Continuation of application No. PCT/CN2019/127504, filed on Dec. 23, 2019.

(30) Foreign Application Priority Data
Jul. 23, 2019 (CN) 201910667611.4

(51) Int. Cl. G06V 20/54; G06V 40/16; G06V 10/56

(52) U.S. Cl. CPC G06V 20/54; G06V 10/56; G06V 40/166

(57) ABSTRACT

The present disclosure relates to surveillance systems and methods. The surveillance methods may include converting first digital multimedia data from a first initial format into a first target format and a second target format; obtaining first intelligent data based on the first digital multimedia data of the first target format; generating first analog multimedia data by performing mixing, encoding and digital-analog conversion on the first digital multimedia data of the second target format and the first intelligent data; and transmitting the first analog multimedia data via a coaxial cable.

### CROSS-REFERENCE TO RELATED APPLICATIONS

This application is a Continuation of International Application No. PCT/CN2019/127504, filed on Dec. 23, 2019, which claims priority of Chinese Application No. 201910667611.4, filed on Jul. 23, 2019, the contents of which are incorporated herein in its entirety by reference.

### TECHNICAL FIELD

The present disclosure generally relates to communication technology, and more particularly, to surveillance systems and methods.

### BACKGROUND

With the widespread application of artificial intelligence represented by deep learning in the field of security, more and more intelligent monitoring systems have been developed. The intelligent monitoring systems may need to transmit video information and lossless auxiliary data (such as a video frame ID, a video time stamp, intelligent structured information in the video, etc.). Traditional analog monitoring system may use coaxial cables to connect video capturing devices (such as analog cameras, HDCVI cameras, etc.) and processing devices (such as DVRs, display devices, etc.) to transmit video information. With the popularization of intelligent monitoring systems, demands for intelligent monitoring system is getting stronger. Therefore, it is necessary to provide systems and methods for implementing intelligent monitoring by using the existing coaxial cables of the traditional analog monitoring system, so as to save resource consumptions and costs, and to improve poor synchronizations.

### SUMMARY

An aspect of the present disclosure introduces a surveillance system. The surveillance system may include at least one storage medium including a set of instructions for transmitting data and at least one processor in communication with the storage medium. When executing the set of instructions, the at least one processor may be directed to perform the following operations. The system may convert first digital multimedia data from a first initial format into a first target format and a second target format. The system may obtain first intelligent data based on the first digital multimedia data of the first target format. The system may generate first analog multimedia data by performing mixing, encoding and digital-analog conversion on the first digital multimedia data of the second target format and the first intelligent data. The system may also transmit the first analog multimedia data via a coaxial cable.

In some embodiments, the first intelligent data may be associated with a target detected or recognized based on the first digital multimedia data.

In some embodiments, the first intelligent data may include at least one of human face detection data, human shape detection data, human face tracking data, human shape tracking data, or data relating to vehicle structures.

In some embodiments, the first target format or the second target format may include at least one of YUV, RGB, or YCbCr.

In some embodiments, the at least one processor may be further directed to perform the following operations of obtaining the first digital multimedia data.

In some embodiments, the at least one processor may be further directed to perform the following operations. The processor may receive second analog multimedia data from the coaxial cable. The processor may obtain second digital multimedia data and second intelligent data by performing analog-digital conversion, decoding. The processor may also separate on the second analog multimedia data. The processor may convert the second digital multimedia data from a second initial format into at least one format and the second intelligent data from a third initial format into at least one format.

In some embodiments, the converting the second digital multimedia data from a second initial format into at least one format and the second intelligent data from a third initial format into at least one format may include: converting the second digital multimedia data from the second initial format into a third target format and the second intelligent data from the third initial format into a fourth target format. The at least one processor may further be directed to perform the following operations including encoding the second digital multimedia data of the third target format and the second intelligent data of the fourth target format.

In some embodiments, the converting the second digital multimedia data from a second initial format into at least one format and the second intelligent data from a third initial format into at least one format may also include: converting the second digital multimedia data from the second initial format into a fifth target format and the second intelligent data from the third initial format into a sixth target format. The at least one processor may further be directed to perform operations including: superimposing the second intelligent data of the sixth target format on the second digital multimedia data of the fifth target format for display.

In some embodiments, the at least one processor may further be directed to perform the following operations. The processor may cache the second digital multimedia data and the second intelligent data.

In some embodiments, the at least one format may include at least one of YUV, RGB, or YCbCr.

In some embodiments, the first intelligent data and the first digital multimedia data of the second target format may be processed in parallel.

According to another aspect of the present disclosure, a surveillance method may be provided. The method may include converting first digital multimedia data from a first initial format into a first target format and a second target format. The method may include obtaining first intelligent data based on the first digital multimedia data of the first target format. The method may include generating first analog multimedia data by performing mixing, encoding and digital-analog conversion on the first digital multimedia data of the second target format and the first intelligent data. The method may also include transmitting the first analog multimedia data via a coaxial cable.

According to another aspect of the present disclosure, a surveillance camera may be provided. The surveillance camera may include a capturing module configured to capture first digital multimedia data; a format conversion module configured to convert the first digital multimedia data from a first initial format into a first target format and a second target format; an intelligent analysis module configured to obtain first intelligent data based on the first digital multimedia data of the first target format; an encoding module configured to generate first analog multimedia data by performing mixing, encoding and digital-analog conversion on the first digital multimedia data of the second target format and the first intelligent data; and a transmitting module configured to transmit the first analog multimedia data via a coaxial cable.

According to still another aspect of the present disclosure, a processing device may be provided. The processing device may include an obtaining module configured to receive second analog multimedia data from a coaxial cable; a decoding module configured to obtain second digital multimedia data and second intelligent data by performing analog-digital conversion, decoding, and separation on the second analog multimedia data; and at least one format conversion module configured to convert the second digital multimedia data from a second initial format into at least one format and the second intelligent data from a third initial format into at least one format.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary surveillance system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary surveillance system according to some embodiments of the present disclosure;

FIG. 5 is a block diagram illustrating an exemplary surveillance camera according to some embodiments of the present disclosure;

FIG. 6 is a block diagram illustrating an exemplary processing device according to some embodiments of the present disclosure;

FIG. 7 is a flowchart illustrating an exemplary surveillance process according to some embodiments of the present disclosure;

FIG. 8 is a flowchart illustrating an exemplary surveillance process according to some embodiments of the present disclosure;

FIG. 9 is a flowchart illustrating an exemplary process for processing digital multimedia data according to some embodiments of the present disclosure;

FIG. 10 is a flowchart illustrating an exemplary process for processing digital multimedia data according to some embodiments of the present disclosure; and

FIG. 11 is a schematic diagram illustrating exemplary surveillance process according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) is for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

An aspect of the present disclosure relates to surveillance systems and methods. To this end, the surveillance systems and methods may extract intelligent data associated with a target from digital multimedia data. The surveillance systems and methods may use an encoding module that supports transmitting hybrid data to mix, encode, and convert the digital multimedia data and the intelligent data to analog multimedia data. The analog multimedia data and the intelligent data are synchronous. The analog multimedia data together with the intelligent data may be transmitted via traditional channels, such as traditional coaxial cables. In addition, the surveillance systems and methods may use a decoding module to convert, decode, and separate the obtained analog multimedia data to obtain the intelligent data together with the digital multimedia data. The obtained digital multimedia data and the obtained intelligent data may not only be used for displaying according to an on-screen display (OSD), but also for other applications, such as sending to a server or other processing modules to be processed. In this way, the analog multimedia data and the synchronous intelligent data may be transmitted via the traditional channels, such as the traditional coaxial cables, in order to save resource consumptions and costs. Poor synchronizations may be improved.

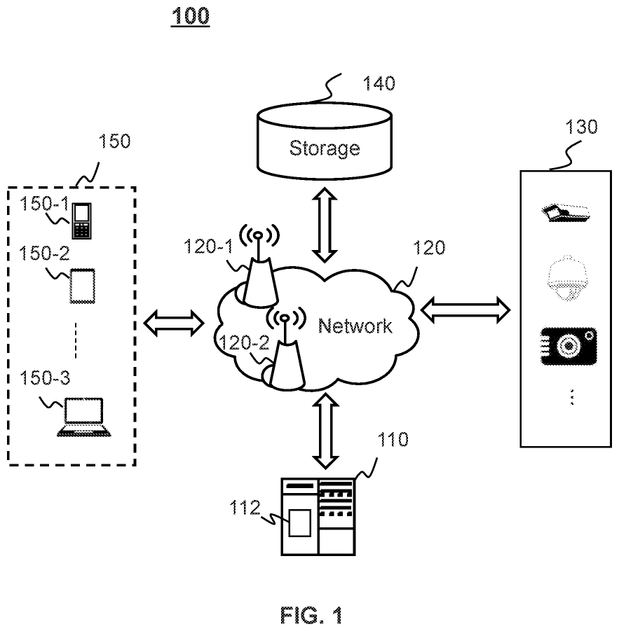

FIG. 1 is a schematic diagram of an exemplary surveillance system 100 according to some embodiments of the present disclosure. The system 100 may include a server 110, a network 120, a surveillance camera 130, a storage 140, and a processing device 150.

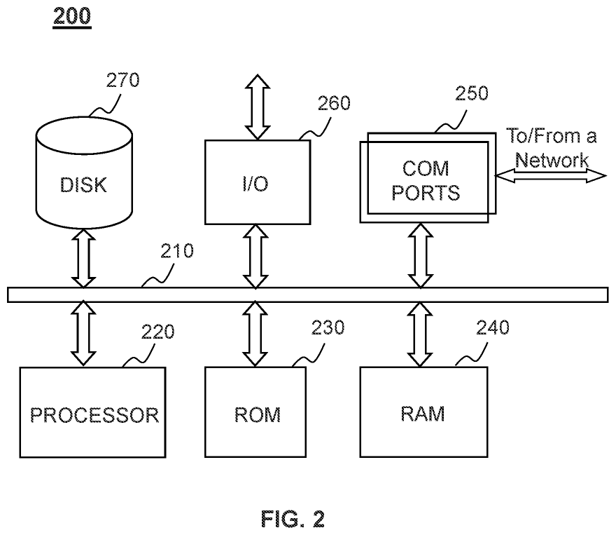

The server 110 may be configured to process information and/or data relating to multimedia data obtained from the surveillance camera 130. For example, the server 110 may send instructions to the surveillance camera 130, the storage 140, or the processing device 150. As another example, the server 110 may receive and process the multimedia data obtained from the surveillance camera 130. As still another example, the server 110 may receive and process intelligent data relating to a target detected or recognized from the multimedia data obtained from the surveillance camera 130. In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the surveillance camera 130, the processing device 150, and/or the storage 140 via the network 120. As another example, the server 110 may connect the surveillance camera 130, the processing device 150, and/or the storage 140 to access stored information and/or data. In some embodiments, the server 110 may be implemented on a cloud platform. Merely byway of example, the cloud platform may be a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to multimedia data obtained from the surveillance camera 130. For example, the processing engine 112 may send instructions to the surveillance camera 130, the storage 140, or the processing device 150. As another example, the processing engine 112 may receive and process the multimedia data obtained from the surveillance camera 130. As still another example, the processing engine 112 may receive and process intelligent data relating to a target detected or recognized from the multimedia data obtained from the surveillance camera 130. In some embodiments, the processing engine 112 may include one or more processing engines (e.g., single-core processing engine(s) or multi-core processor(s)). Merely by way of example, the processing engine 112 may be one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction set computer (RISC), a microprocessor, or the like, or any combination thereof.

The network 120 may facilitate the exchange of information and/or data. In some embodiments, one or more components of the system 100 (e.g., the server 110, the surveillance camera 130, the storage 140, and the processing device 150) may transmit information and/or data to other component(s) in the system 100 via the network 120. For example, the server 110 may obtain multimedia data from the surveillance camera 130 via the network 120. As another example, the server 110 may direct the processing device 150 to display via the network 120. In some embodiments, the network 120 may be any type of wired or wireless network, or combination thereof. Merely by way of example, the network 120 may be a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the system 100 may be connected to the network 120 to exchange data and/or information between them.

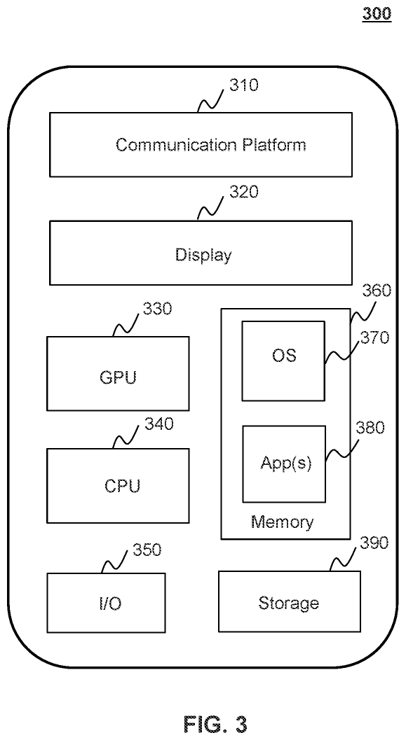

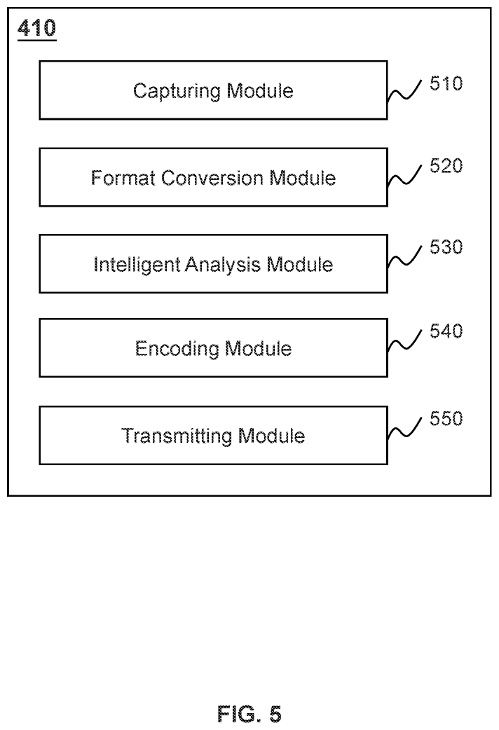

The surveillance camera 130 may be any electronic device that is capable of capturing images or videos. For example, the surveillance camera 130 may include an image sensor, a video recorder, or the like, or any combination thereof. In some embodiments, the surveillance camera 130 may include any suitable type of camera, such as a fixed camera, a fixed dome camera, a covert camera, a Pan-Tilt-Zoom (PTZ) camera, a thermal camera, or the like, or any combination thereof. In some embodiments, the surveillance camera 130 may further include at least one network port. The at least one network port may be configured to send information to and/or receive information from one or more components in the system 100 (e.g., the server 110, the storage 140) via the network 120. In some embodiments, the surveillance camera 130 may be implemented on a computing device 200 having one or more components illustrated in FIG. 2, or a mobile device 300 having one or more components illustrated in FIG. 3, or a surveillance camera 130 having one or more modules illustrated in FIG. 5 in the present disclosure.

The storage 140 may store data and/or instructions. For example, the storage 140 may store data obtained from the surveillance camera 130 (e.g., multimedia data). As another example, the storage 140 may store digital multimedia data transmitted from the surveillance camera 130 and intelligent data extracted from the digital multimedia data. As still another example, the storage 140 may store data and/or instructions that the server 110 may execute or use to perform exemplary methods described in the present disclosure. In some embodiments, the storage 140 may be a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 140 may be implemented on a cloud platform. Merely by way of example, the cloud platform may be a private cloud, a public cloud, a hybrid cloud, a community cloud, a distributed cloud, an inter-cloud, a multi-cloud, or the like, or any combination thereof.

In some embodiments, the storage 140 may include at least one network port to communicate with other devices in the system 100. For example, the storage 140 may be connected to the network 120 to communicate with one or more components of the system 100 (e.g., the server 110, the surveillance camera 130, the processing device 150) via the at least one network port. One or more components in the system 100 may access the data or instructions stored in the storage 140 via the network 120. In some embodiments, the storage 140 may be directly connected to or communicate with one or more components in the system 100 (e.g., the server 110, the surveillance camera 130, the processing device 150). In some embodiments, the storage 140 may be part of the server 110.

FIG. 2 is a schematic diagram illustrating exemplary hardware and software components of a computing device 200 on which the server 110, the surveillance camera 130, and/or the processing device 150 may be implemented according to some embodiments of the present disclosure. For example, the processing engine 112 may be implemented on the computing device 200 and configured to perform functions of the processing engine 112 disclosed in this disclosure. As another example, the processing device 150 may be implemented on the computing device 200 and configured to perform functions of the processing device 150 disclosed in this disclosure.

The computing device 200 may be used to implement a system 100 for the present disclosure. The computing device 200 may be used to implement any component of system 100 that performs one or more functions disclosed in the present disclosure. For example, the processing engine 112 may be implemented on the computing device 200, via its hardware, software program, firmware, or a combination thereof. Although only one such computer is shown, for convenience, the computer functions relating to the online to offline service as described herein may be implemented in a distributed fashion on a number of similar platforms, to distribute the processing load.

The computing device 200, for example, may include COM ports 250 connected to and from a network connected thereto to facilitate data communications. The COM port 250 may be any network port or data exchange port to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. The processing circuits may also generate electronic signals including the conclusion or the result and a triggering code. In some embodiments, the trigger code may be in a format recognizable by an operation system (or an application installed therein) of an electronic device (e.g., the surveillance camera 130, the processing device 150) in the system 100. For example, the trigger code may be an instruction, a code, a mark, a symbol, or the like, or any combination thereof, that can activate certain functions and/or operations of a mobile phone or let the mobile phone execute a predetermined program(s). In some embodiments, the trigger code may be configured to rend the operation system (or the application) of the electronic device to generate a presentation of the conclusion or the result (e.g., a video or intelligent data) on an interface of the electronic device. Then the interface circuits may send out the electronic signals from the processing circuits via the bus 210.

The exemplary computing device may include the internal communication bus 210, program storage and data storage of different forms including, for example, a disk 270, and a read-only memory (ROM) 230, or a random access memory (RAM) 240, for various data files to be processed and/or transmitted by the computing device. The exemplary computing device may also include program instructions stored in the ROM 230, RAM 240, and/or other types of non-transitory storage medium to be executed by the processor 220. The methods and/or processes of the present disclosure may be implemented as the program instructions. The exemplary computing device may also include operating systems stored in the ROM 230, RAM 240, and/or other types of non-transitory storage medium to be executed by the processor 220. The program instructions may be compatible with the operating systems for providing the online to offline service. The computing device 200 also includes an I/O component 260, supporting input/output between the computer and other components. For example, the I/O component 260 may include a display screen. The computing device 200 may also receive programming and data via network communications.

Merely for illustration, only one processor is illustrated in FIG. 2. Multiple processors are also contemplated; thus, operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

FIG. 3 is a schematic diagram illustrating exemplary hardware and/or software components of an exemplary mobile device 300 on which the server 110, the surveillance camera 130, and/or the processing device 150 may be implemented according to some embodiments of the present disclosure.

As illustrated in FIG. 3, the mobile device 300 may include a communication platform 310, a display 320, a graphics processing unit (GPU) 330, a central processing unit (CPU) 340, an I/O 350, a memory 360, and a storage 390. The CPU may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the surveillance system 100. User interactions with the information stream may be achieved via the I/O devices 350 and provided to the processing engine 112 and/or other components of the system 100 via the network 120.

To implement various modules, units, and their functionalities described in the present disclosure, computer hardware platforms may be used as the hardware platform(s) for one or more of the elements described herein (e.g., the system 100, and/or other components of the system 100 described with respect to FIGS. 1-11). The hardware elements, operating systems and programming languages of such computers are conventional in nature, and it is presumed that those skilled in the art are adequately familiar therewith to adapt those technologies to automatically adjust the aperture of the surveillance camera 130 as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result, the drawings should be self-explanatory.

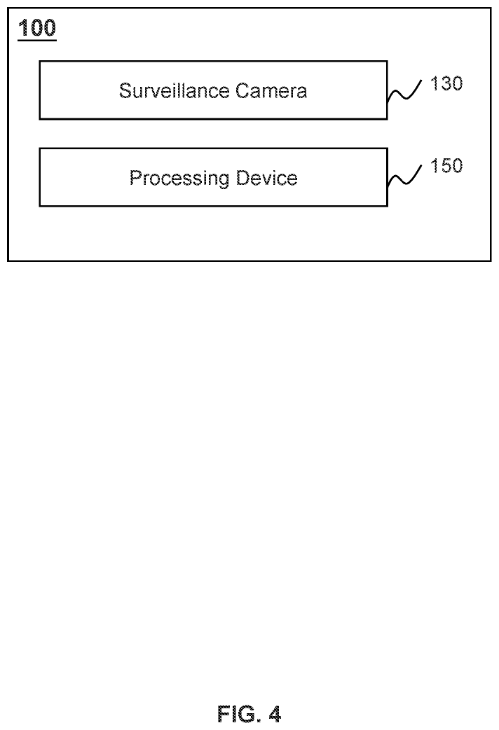

FIG. 4 is a block diagram illustrating an exemplary surveillance system 100 according to some embodiments of the present disclosure. As illustrated in FIG. 4, the surveillance system 100 may include a surveillance camera 130 and a processing device 150.

The surveillance camera 130 may be configured to capture data, process data, and/or transmit data to the processing device 150. For example, the surveillance camera 130 may include one or more modules as illustrated FIG. 5, and perform the corresponding operations.

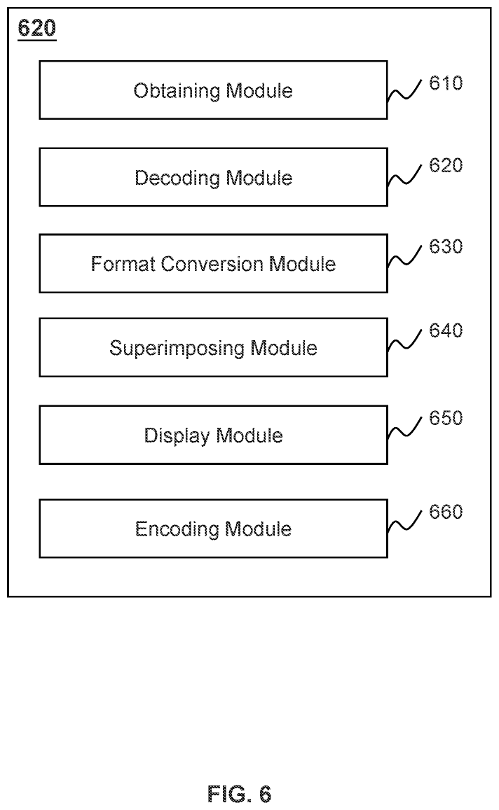

The processing device 150 may be configured to receive data, process data, and/or display data. For example, the processing device 150 may include one or more modules as illustrated FIG. 6, and perform the corresponding operations.

The surveillance camera 130 and the processing device 150 may be connected to or communicate with each other via a wired connection or a wireless connection. The wired connection may be a metal cable, an optical cable, a hybrid cable, a coaxial cable, or the like, or any combination thereof. The wireless connection may be a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the surveillance camera 130 may be divided into two or more units or modules as illustrated in FIG. 5. As another example, the processing device 150 may be divided into two or more units or modules as illustrated in FIG. 6. As still another example, the surveillance system 100 may include a storage module (not shown) used to store data and/or information.

FIG. 5 is a block diagram illustrating an exemplary surveillance camera 130 according to some embodiments of the present disclosure. As illustrated in FIG. 5, the surveillance camera 130 may include a capturing module 510, a format conversion module 520, an intelligent analysis module 530, an encoding module 540, and a transmitting module 550.

The capturing module 510 may be configured to capture data. For example, the capturing module 510 may capture original digital multimedia data and process the original digital multimedia data to obtain the first digital multimedia data. As another example, the capturing module 510 may capture the first digital multimedia data.

The format conversion module 520 may be configured to convert a format of received data. In some embodiments, the format conversion module 520 may convert the first digital multimedia data from a first initial format into a plurality of target formats. For example, the format conversion module 520 may convert the first digital multimedia data from the first initial format into a first target format and a second target format.

The intelligent analysis module 530 may be configured to extract intelligent information from received information. In some embodiments, the intelligent analysis module 530 may obtain first intelligent data based on the first digital multimedia data of the first target format. For example, the intelligent analysis module 530 may extract the first intelligent data from the first digital multimedia data of the first target format.

The encoding module 540 may be configured to process received data. In some embodiments, the encoding module 540 may generate first analog multimedia data by performing mixing, encoding and digital-analog conversion on the first digital multimedia data of the second target format and the first intelligent data. In some embodiments, the encoding module 540 may include one or more units for performing mixing, encoding and digital-analog conversion, respectively. For example, the encoding module 540 may include a mixing unit for mixing the first digital multimedia data of the second target format and the first intelligent data. As another example, the encoding module 540 may include an encoding unit for encoding the mixed first digital multimedia data. As still another example, the encoding module 540 may include a digital-analog conversion unit to convert the first digital multimedia data into the first analog multimedia data.

The transmitting module 550 may be configured to transmit data. For example, the transmitting module 550 may transmit the first analog multimedia data via a coaxial cable.

Two or more modules of the surveillance camera 130 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the encoding module 540 and the transmitting module 550 may be integrated into one module.

FIG. 6 is a block diagram illustrating an exemplary processing device 150 according to some embodiments of the present disclosure. As illustrated in FIG. 6, the processing device 150 may include an obtaining module 610, a decoding module 620, a format conversion module 630, a superimposing module 640, a display module 650, and an encoding module 660.

The obtaining module 610 may be configured to obtain information. For example, the obtaining module 610 may obtain second analog multimedia data from surveillance camera 130 via the coaxial cable.

The decoding module 620 may be configured to process received data. In some embodiments, the decoding module 620 may obtain second digital multimedia data and second intelligent data by performing analog-digital conversion, decoding, and separation on the second analog multimedia data. In some embodiments, the decoding module 620 may include one or more units for analog-digital conversion, decoding, and separation, respectively. For example, the decoding module 620 may include an analog-digital conversion unit to convert the second analog multimedia data into the second digital multimedia data. As another example, the decoding module 620 may include a decoding unit to decode digital multimedia data. As still another example, the decoding module 620 may include a separation unit to separate the second digital multimedia data and the second intelligent data from the decoded digital multimedia data.

The format conversion module 630 may be configured to convert a format of received data. In some embodiments, the format conversion module 630 may convert the second digital multimedia data from a second initial format into at least one format and the second intelligent data from a third initial format into at least one format. For example, the format conversion module 630 may convert the second digital multimedia data from the second initial format into a third target format and the second intelligent data from the third initial format into a fourth target format. As another example, the format conversion module 630 may convert the second digital multimedia data from the second initial format into a fifth target format and the second intelligent data from the third initial format into a sixth target format.

The superimposing module 640 may be configured to superimpose received data. For example, the superimposing module 640 may superimpose the second intelligent data of the sixth target format on the second digital multimedia data of the fifth target format for display.

The display module 650 may be configured to display received data. For example, the display module 650 may display the second digital multimedia data superimposed with the second intelligent data.

The encoding module 660 may be configured to encode received data. For example, the encoding module 660 may encode the second digital multimedia data of the third target format and the second intelligent data of the fourth target format.

Two or more modules of the processing device 150 may be connected to or communicate with each other via a wired connection or a wireless connection. The wired connection may be a metal cable, an optical cable, a hybrid cable, or the like, or any combination thereof. The wireless connection may be a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units.

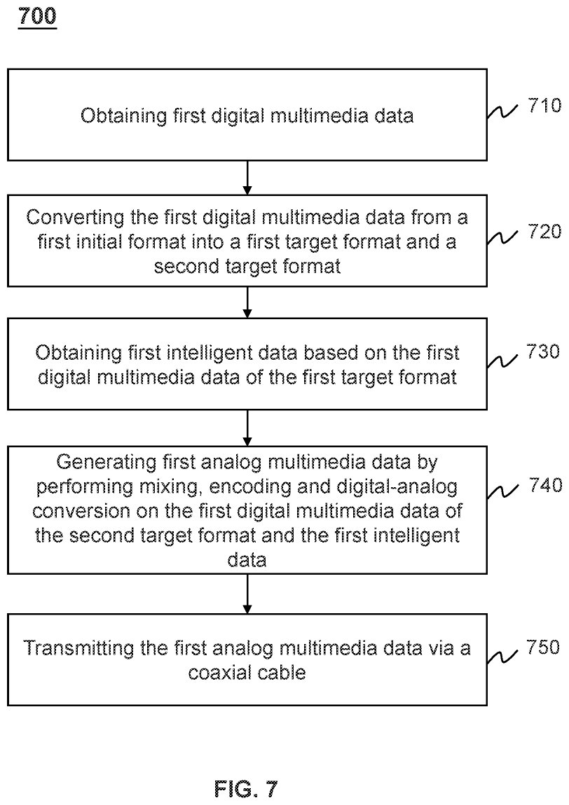

FIG. 7 is a flowchart illustrating an exemplary surveillance process 700 according to some embodiments of the present disclosure. The process 700 may be executed by the system 100. For example, the process 700 may be implemented as a set of instructions (e.g., an application) stored in the storage ROM 230 or the RAM 240. The processor 220 may execute the set of instructions, and when executing the instructions, it may be configured to perform the process 700. As another example, the process 700 may be executed by the surveillance camera 130 (or the surveillance camera 130). The operations of the illustrated process presented below are intended to be illustrative. In some embodiments, the process 700 may be accomplished with one or more additional operations not described and/or without one or more of the operations discussed. Additionally, the order in which the operations of the process as illustrated in FIG. 7 and described below is not intended to be limiting.

In 710, the processing engine 112 (e.g., the processor 220) may obtain first digital multimedia data.

In some embodiments, the first digital multimedia data may include a plurality of content forms such as text, audio, images, animations, video, interactive content, or the like, or any combination thereof. In some embodiments, the surveillance camera 130 (e.g., the capturing module 510) may capture original digital multimedia data and process the original digital multimedia data to obtain the first digital multimedia data. The surveillance camera 130 may send the first digital multimedia data to the processing engine 112. In some embodiments, the surveillance camera 130 (e.g., the capturing module 510) may capture the first digital multimedia data directly.

In 720, the processing engine 112 (e.g., the processor 220) or the surveillance camera 130 (e.g., the format conversion module 520) may convert the first digital multimedia data from a first initial format into a first target format and a second target format.

In some embodiments, the first initial format, the first target format, and/or the second target format may be a format of the first digital multimedia data. For example, the first digital multimedia data includes video data. The first initial format, the first target format, and/or the second target format may include YUV, RGB, YCbCr, YPbPr, CMYK, or the like, or any combination thereof. In some embodiments, the first target format and/or the second target format may be determined by a required format of a module to which the first digital multimedia data is sent. For example, if the first target format of the first digital multimedia data is sent to the intelligent analysis module 530, the first target format may be a required format of the intelligent analysis module 530. As another example, if the second target format of the first digital multimedia data is sent to the encoding module 540, the second target format may be a required format of the encoding module 540. In some embodiments, the first initial format, the first target format, and/or the second target format may be the same with or different from each other.

In some embodiments, the processing engine 112 or the surveillance camera 130 may convert the first digital multimedia data from the first initial format into the first target format and/or the second target format according to a format converting algorithm. For example, the format converting algorithm may be a formula that converts the first initial format into the first target format and/or the second target format. In some embodiments, the format converting algorithm may be stored in a storage device (e.g., the storage 140, the ROM 230 or the RAM 240, etc.) or the format conversion module 520.

In 730, the processing engine 112 (e.g., the processor 220) or the surveillance camera 130 (e.g., the intelligent analysis module 530) may obtain first intelligent data based on the first digital multimedia data of the first target format.

In some embodiments, the first intelligent data may be associated with a target detected or recognized based on the first digital multimedia data. For example, the first intelligent data may reflect the characteristics of the target in the first digital multimedia data. In some embodiments, the first digital multimedia data includes video data, and the first intelligent data may be extracted from the video data. The target may include a human, a human face, a vehicle, an animal, or any object, or the combination thereof. In some embodiments, the first digital multimedia data includes audio data, and the first intelligent data may be extracted from the audio data. The target may include a human voice, an animal voice, a sound made by a machine, or the like, or any combination thereof. In some embodiments, the processing engine 112 or the intelligent analysis module 530 may extract the first intelligent data from the first digital multimedia data of the first target format. For example, the target may be detected or recognized from the first digital multimedia data of the first target format according to a machine learning algorithm. The first intelligent data may be multimedia data relating to the target. In some embodiments, the first intelligent data may be obtained according to different function configurations. For example, the first intelligent data may include human face detection data, human shape detection data, human face tracking data, human shape tracking data, data relating to vehicle structures, or the like, or any combination thereof.

In 740, the processing engine 112 (e.g., the processor 220) or the surveillance camera 130 (e.g., the encoding module 540) may generate first analog multimedia data by performing mixing, encoding and digital-analog conversion on the first digital multimedia data of the second target format and the first intelligent data.

In some embodiments, the first analog multimedia data may be composite video signals. In some embodiments, a signal standard of the first analog multimedia data may include phase alteration line (PAL), national television standards committee (NTSC), high definition composite video interface (HDCVI), 720P25Fps, 720P30Fps, 720P50Fps, 720P60Fps, 1080P25Fps, 1080P30Fps, 1080P50Fps, 1080P60Fps, 2K25Fps, 2K30Fps, 4K25Fps, 4K30Fps, or the like, or any combination thereof.

In some embodiments, the first intelligent data and the first digital multimedia data of the second target format may be processed in parallel. For example, the first intelligent data may be synchronous with the second digital multimedia data. In some embodiments, the processing engine 112 or the encoding module 540 may generate a first data frame based on the first intelligent data. For example, the processing engine 112 or the encoding module 540 may generate a first frame header, a first frame footer, and first data of the first data frame. The first data of the first data frame may be generated by encoding the first intelligent data according to a predetermined encoding algorithm. In some embodiments, the processing engine 112 or the encoding module 540 may mix the first intelligent data and the first digital multimedia data of the second target format by inserting the first data frame of the first intelligent data into an area of the first digital multimedia data of the second target format. In some embodiments, the processing engine 112 or the encoding module 540 may encode and perform digital-analog conversion on the mixed multimedia data to obtain the first analog multimedia data. Exemplary processes for performing mixing, encoding and digital-analog conversion on the first digital multimedia data of the second target format and the first intelligent data may be the same as the process described in Chinese Application No. 201610575545.4.

In 750, the processing engine 112 (e.g., the processor 220) or the surveillance camera 130 (e.g., the transmitting module 550) may transmit the first analog multimedia data via a coaxial cable.

In some embodiments, the intelligent data is transmitted together with the digital multimedia data via the coaxial cable that is used in analog surveillance systems. The transmission resource is saved, and the problems of poor synchronizations and high costs during transmitting digital multimedia data and digital intelligent data are solved.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more other optional operations (e.g., a storing operation) may be added elsewhere in the exemplary process 700.

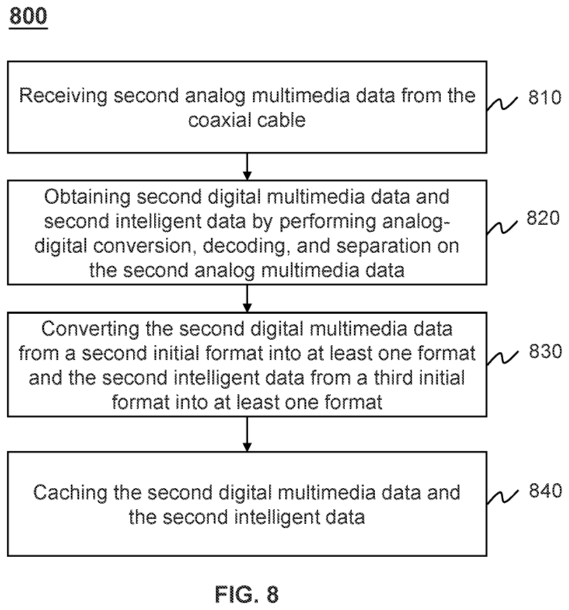

FIG. 8 is a flowchart illustrating an exemplary surveillance process 800 according to some embodiments of the present disclosure. The process 800 may be executed by the system 100. For example, the process 800 may be implemented as a set of instructions (e.g., an application) stored in the storage ROM 230 or the RAM 240. The processor 220 may execute the set of instructions, and when executing the instructions, it may be configured to perform the process 800. As another example, the process 800 may be executed by the processing device 150. The operations of the illustrated process presented below are intended to be illustrative. In some embodiments, the process 800 may be accomplished with one or more additional operations not described and/or without one or more of the operations discussed. Additionally, the order in which the operations of the process as illustrated in FIG. 8 and described below is not intended to be limiting.

In 810, the processing engine 112 (e.g., the processor 220) or the processing device 150 (e.g., the obtaining module 610) may obtain second analog multimedia data from the coaxial cable.

In some embodiments, the second analog multimedia data may be composite video signals. In some embodiments, a signal standard of the second analog multimedia data may include phase alteration line (PAL), national television standards committee (NTSC), high definition composite video interface (HDCVI), 720P25Fps, 720P30Fps, 720P50Fps, 720P60Fps, 1080P25Fps, 1080P30Fps, 1080P50Fps, 1080P60Fps, 2K25Fps, 2K30Fps, 4K25Fps, 4K30Fps, or the like, or any combination thereof.

In some embodiments, the second analog multimedia data may correspond to the first analog multimedia data. For example, if the first analog multimedia data is transmitted inerrably via the coaxial cable, the second analog multimedia data may be the same with the first analog multimedia data. In some embodiments, the second analog multimedia data may include information relating to digital multimedia data and intelligent data.

In 820, the processing engine 112 (e.g., the processor 220) or the processing device 150 (e.g., the decoding module 620) may obtain second digital multimedia data and second intelligent data by performing analog-digital conversion, decoding, and separation on the second analog multimedia data.

In some embodiments, the processing engine 112 or the decoding module 620 may perform analog-digital conversion on the second analog multimedia data to convert the second analog multimedia data into digital multimedia data. The processing engine 112 or the decoding module 620 may decode and separate the digital multimedia data after the analog-digital conversion to obtain the second digital multimedia data and second intelligent data. For example, the processing engine 112 or the decoding module 620 may detect a second frame header of a second data frame. The second data frame may include second data encoded by the second intelligent data. In some embodiments, the second frame header may be corresponding to the first frame. For example, the second frame header may the same, complementary, or have relationships with the first frame header. In some embodiments, the processing engine 112 or the decoding module 620 may extract the second data from the digital multimedia data after the analog-digital conversion and decode the second data according to a predetermined decoding algorithm to obtain the second intelligent data. In some embodiments, the processing engine 112 or the decoding module 620 may delete the second data frame from the digital multimedia data after the analog-digital conversion to obtain the second digital multimedia data. Exemplary processes for performing analog-digital conversion, decoding, and separation on the second analog multimedia data to obtain second digital multimedia data and second intelligent data may be the same as the process described in Chinese Application No. 201610575545.4.

In 830, the processing engine 112 (e.g., the processor 220) or the processing device 150 (e.g., the format conversion module 630) may convert the second digital multimedia data from a second initial format into at least one format and the second intelligent data from a third initial format into at least one format.

In some embodiments, the second initial format, the third initial format, the at least one format of the second intelligent data, and/or the at least one format of the second digital multimedia data may be a format of the second digital multimedia data and/or the second intelligent data. For example, the second digital multimedia data includes video data. The second initial format, the third initial format, and/or the at least one format may include YUV, RGB, YCbCr, YPbPr, CMYK, or the like, or any combination thereof. In some embodiments, the at least one format of the second digital multimedia data and/or the at least one format of the second intelligent data may be determined by a required format of a module to which the second digital multimedia data and/or the second intelligent data are sent. For example, if the second digital multimedia data is sent to the encoding module 660. The at least one format of the second digital multimedia data may include a required format of the encoding module 660. As another example, if the second intelligent data is sent to an intelligent analysis module. The at least one format of the second intelligent data may include a required format of the intelligent analysis module. In some embodiments, the second initial format, the third initial format, the at least one format of the second intelligent data, the at least one format of the second digital multimedia data, the first initial format, the first target format, and/or the second target format may be the same with or different from each other.

In some embodiments, the at least one format of the second intelligent data and/or the at least one format of the second digital multimedia data may be used for a plurality applications. For example, one of the at least one format of the second digital multimedia data and one of the at least one format of the second intelligent data may be used for displaying on the display module 650. As another example, one of the at least one format of the second digital multimedia data and one of the at least one format of the second intelligent data may be sent to the server 110 or any other modules to be stored or processed.

In 840, the processing engine 112 (e.g., the processor 220) or the processing device 150 (e.g., the format conversion module 630 or the catching module) may cache the second digital multimedia data and the second intelligent data.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing operation) may be added elsewhere in the exemplary process 800.

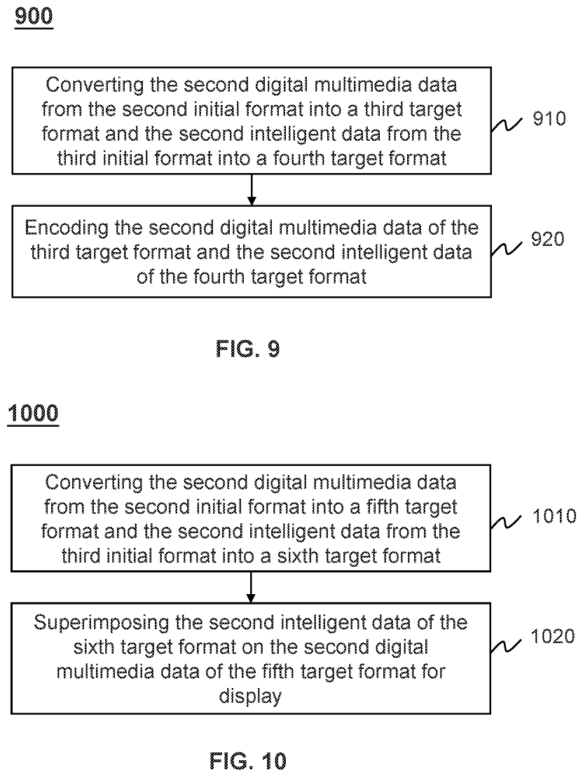

FIG. 9 is a flowchart illustrating an exemplary process 900 for processing digital multimedia data according to some embodiments of the present disclosure. The process 900 may be executed by the system 100. For example, the process 900 may be implemented as a set of instructions (e.g., an application) stored in the storage ROM 230 or the RAM 240. The processor 220 may execute the set of instructions, and when executing the instructions, it may be configured to perform the process 900. As another example, the process 900 may be executed by the processing device 150. The operations of the illustrated process presented below are intended to be illustrative. In some embodiments, the process 900 may be accomplished with one or more additional operations not described and/or without one or more of the operations discussed. Additionally, the order in which the operations of the process as illustrated in FIG. 9 and described below is not intended to be limiting.

In 910, the processing engine 112 (e.g., the processor 220) or the processing device 150 (e.g., the format conversion module 630) may convert the second digital multimedia data from the second initial format into a third target format and the second intelligent data from the third initial format into a fourth target format.

In some embodiments, the converting the second digital multimedia data from a second initial format into at least one format and the second intelligent data from a third initial format into at least one format may include converting the second digital multimedia data from the second initial format into a third target format and/or the second intelligent data from the third initial format into a fourth target format. In some embodiments, the second initial format, the third initial format, the third target format, and/or the fourth target format may be a format of the second digital multimedia data and/or the second intelligent data. For example, the second digital multimedia data includes video data. The second initial format, the third initial format, the third target format, and/or the fourth target format may include YUV, RGB, YCbCr, YPbPr, CMYK, or the like, or any combination thereof. In some embodiments, the third target format and/or the fourth target format may be determined by a required format of a module to which the second digital multimedia data and/or the second intelligent data are sent. For example, if the second digital multimedia data is sent to the encoding module 660. The third target format of the second digital multimedia data may include a required format of the encoding module 660. As another example, if the second intelligent data is sent to an intelligent analysis module. The fourth target format of the second intelligent data may include a required format of the intelligent analysis module. In some embodiments, the second initial format, the third initial format, the third target format, the fourth target format the first initial format, the first target format, and/or the second target format may be the same with or different from each other.

In 920, the processing engine 112 (e.g., the processor 220) or the processing device 150 (e.g., the encoding module 660) may encode the second digital multimedia data of the third target format and the second intelligent data of the fourth target format.

In some embodiments, the processing engine 112 or the encoding module 660 may encode the second digital multimedia data of the third target format and/or the second intelligent data of the fourth target format to a predetermined format. The predetermined format may be determined by a required format of a module to which the second digital multimedia data and/or the second intelligent data are sent. For example, if the second digital multimedia data and/or the second intelligent data are sent to the server 110, the predetermined format may be a required format of the server 110.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional operations (e.g., a storing operation) may be added elsewhere in the exemplary process 900. For example, the second intelligent data of the fourth target format may be sent to an intelligent analysis module to be encoded according to a required format of the intelligent analysis module.

FIG. 10 is a flowchart illustrating an exemplary process 1000 for processing digital multimedia data according to some embodiments of the present disclosure. The process 1000 may be executed by the system 100. For example, the process 1000 may be implemented as a set of instructions (e.g., an application) stored in the storage ROM 230 or the RAM 240. The processor 220 may execute the set of instructions, and when executing the instructions, it may be configured to perform the process 1000. As another example, the process 1000 may be executed by the processing device 150. The operations of the illustrated process presented below are intended to be illustrative. In some embodiments, the process 1000 may be accomplished with one or more additional operations not described and/or without one or more of the operations discussed. Additionally, the order in which the operations of the process as illustrated in FIG. 10 and described below is not intended to be limiting.

In 1010, the processing engine 112 (e.g., the processor 220) or the processing device 150 (e.g., the format conversion module 630) may convert the second digital multimedia data from the second initial format into a fifth target format and the second intelligent data from the third initial format into a sixth target format.

In some embodiments, the converting the second digital multimedia data from a second initial format into at least one format and the second intelligent data from a third initial format into at least one format may include converting second digital multimedia data from the second initial format into a fifth target format and the second intelligent data from the third initial format into a sixth target format. In some embodiments, the second initial format, the third initial format, the fifth target format, and/or the sixth target format may be a format of the second digital multimedia data and/or the second intelligent data. For example, the second digital multimedia data includes video data. The second initial format, the third initial format, the fifth target format, and/or the sixth target format may include YUV, RGB, YCbCr, YPbPr, CMYK, or the like, or any combination thereof. In some embodiments, the fifth target format and/or the sixth target format may be determined by a required format of a module to which the second digital multimedia data and/or the second intelligent data are sent. For example, if the second digital multimedia data is sent to the superimposing module 640. The fifth target format of the second digital multimedia data and/or the sixth target format of the second intelligent data may include a required format of the superimposing module 640. In some embodiments, the first initial format, the second initial format, the third initial format, the first target format, the second target format, the third target format, the fourth target format, the fifth target format, and/or the sixth target format may be the same with or different from each other.

In 1020, the processing engine 112 (e.g., the processor 220) or the processing device 150 (e.g., the superimposing module 640) may superimpose the second intelligent data of the sixth target format on the second digital multimedia data of the fifth target format for display.

In some embodiments, the sixth target format and the fifth target format may be required formats of the superimposing module 640. The superimposing module 640 may superimpose the second intelligent data on the second digital multimedia data according to the required sixth target format and the required fifth target format. In some embodiments, the second digital multimedia data superimposed with the second intelligent data may be sent to the display module 650 for display. On the display module, the second digital multimedia together with the second intelligent data may be displayed together.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more other optional operations (e.g., a storing operation) may be added elsewhere in the exemplary process 1000. For example, the process 1000 may further include an operation for displaying the second digital multimedia data superimposed with the second intelligent data.

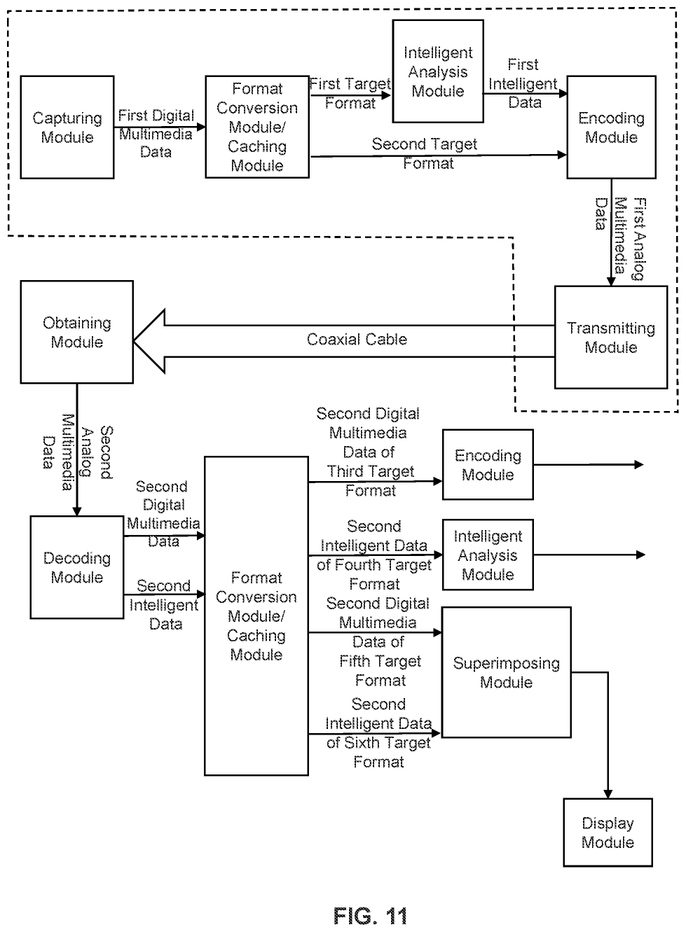

FIG. 11 is a schematic diagram illustrating an exemplary surveillance process according to some embodiments of the present disclosure. As shown in FIG. 11, the surveillance process inside a dotted box may be implemented in the surveillance camera 130 for generating and transmitting data, and the surveillance process outside the dotted box may be implemented in the processing device 150 for receiving, displaying, or processing the data.

At the surveillance camera 130 for generating and transmitting data, the capturing module may capture (or process original digital multimedia data to obtain) first digital multimedia data, and send the first multimedia data to the format conversion module or the caching module. The format conversion module or the caching module may convert the first digital multimedia data from an initial format into a first target format and a second target format. The first digital multimedia data of the first target format may be sent to the intelligent analysis module, and the first digital multimedia data of the second target format may be sent to the encoding module. The intelligent analysis module may extract the first intelligent data from the first digital multimedia data, and send the first intelligent data to the encoding module. The encoding module may perform mixing, encoding and digital-analog conversion on the first digital multimedia data of the second target format and the first intelligent data to obtain first analog multimedia data. In some embodiments, the first intelligent data and the first digital multimedia data of the second target format may be processed in parallel. The first intelligent data and the first digital multimedia data of the second target format may be synchronous. The transmitting module may transmit the first analog multimedia data to the processing device 150 via the coaxial cable.

At the processing device 150 for receiving, displaying, or processing the data, the obtaining module may receive second analog multimedia data and send the second analog multimedia data to the decoding module. In some embodiments, if the first analog multimedia data is transmitted inerrably via the coaxial cable, the second analog multimedia data may be the same with the first analog multimedia data. The decoding module may perform analog-digital conversion, decoding, and separation on the second analog multimedia data to obtain second digital multimedia data and second intelligent data. The format conversion module or the caching module may convert the second digital multimedia data from a second initial format into a third target format and a fifth target format. The format conversion module or the caching module may convert the second intelligent data from a third initial format into a fourth target format and a sixth target format. The second digital multimedia data of the third target format may be sent to the encoding module. The encoding module may encode the second digital multimedia data into a required format of a module to which the second digital multimedia data are sent. For example, if the second digital multimedia data is sent to the server 110, the second digital multimedia data may be encoded as a required format of the server 110. The second intelligent data of the fourth target format may be sent to the intelligent analysis module. The intelligent analysis module may encode the second intelligent data into a required format of a module to which the second intelligent data are sent. The second digital multimedia data of the fifth target format and the second intelligent data of the sixth target format may be sent to the superimposing module. The superimposing module may superimpose the second intelligent data of the sixth target format on the second digital multimedia data of the fifth target format. The second digital multimedia data superimposed with the second intelligent data may be sent to the display module. In some embodiments, the second intelligent data and the second digital multimedia data may be synchronous. The display module may display the second digital multimedia data together with the second intelligent data. One or more modules and the operations performed by the one or more modules in FIG. 11 may be found elsewhere in the present disclosure (e.g., FIGS. 4-10 and the descriptions thereof).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer-readable media having computer-readable program code embodied thereon.

A computer-readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the descriptions, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A surveillance system, comprising:
at least one storage medium including a set of instructions for transmitting data; and
at least one processor in communication with the storage medium, wherein when executing the set of instructions, the at least one processor is directed to perform operations including:
converting first digital multimedia data from a first initial format into a first target format and a second target format;
obtaining first intelligent data based on the first digital multimedia data of the first target format;
generating first analog multimedia data by performing mixing, encoding and digital-analog conversion on the first digital multimedia data of the second target format and the first intelligent data; and
transmitting the first analog multimedia data via a coaxial cable.

2. The surveillance system of claim 1, wherein the first intelligent data is associated with a target detected or recognized based on the first digital multimedia data.

3. The surveillance system of claim 2, wherein the first intelligent data includes at least one of:
human face detection data;
human shape detection data;
human face tracking data;
human shape tracking data; or
data relating to vehicle structures.

4. The surveillance system of claim 1, wherein the first target format or the second target format includes at least one of:
YUV;
RGB; or
YCbCr.

5. The surveillance system of claim 1, wherein the at least one processor is further directed to perform operations including:
obtaining the first digital multimedia data.

6. The surveillance system of claim 1, wherein the at least one processor is further directed to perform operations including:
receiving second analog multimedia data from the coaxial cable;
obtaining second digital multimedia data and second intelligent data by performing analog-digital conversion, decoding, and separation on the second analog multimedia data; and
converting the second digital multimedia data from a second initial format into at least one format and the second intelligent data from a third initial format into at least one format.

7. The surveillance system of claim 6, wherein the converting the second digital multimedia data from a second initial format into at least one format and the second intelligent data from a third initial format into at least one format includes:
converting the second digital multimedia data from the second initial format into a third target format and the second intelligent data from the third initial format into a fourth target format; and
wherein the at least one processor is further directed to perform operations including:
encoding the second digital multimedia data of the third target format and the second intelligent data of the fourth target format.

8. The surveillance system of claim 6, wherein the converting the second digital multimedia data from a second initial format into at least one format and the second intelligent data from a third initial format into at least one format includes:
converting the second digital multimedia data from the second initial format into a fifth target format and the second intelligent data from the third initial format into a sixth target format; and
wherein the at least one processor is further directed to perform operations including:
superimposing the second intelligent data of the sixth target format on the second digital multimedia data of the fifth target format for display.

9. The surveillance system of claim 6, wherein the at least one processor is further directed to perform operations including:
caching the second digital multimedia data and the second intelligent data.

10. The surveillance system of claim 6, wherein the at least one format includes at least one of:
YUV;
RGB; or
YCbCr.

11. The surveillance system of claim 1, wherein the first intelligent data and the first digital multimedia data of the second target format are processed in parallel.

12. A surveillance method, comprising:
converting first digital multimedia data from a first initial format into a first target format and a second target format;
obtaining first intelligent data based on the first digital multimedia data of the first target format;
generating first analog multimedia data by performing mixing, encoding and digital-analog conversion on the first digital multimedia data of the second target format and the first intelligent data; and
transmitting the first analog multimedia data via a coaxial cable.

13. The surveillance method of claim 12, the first intelligent data is associated with a target detected or recognized based on the first digital multimedia data.

14. The surveillance method of claim 13, wherein the first intelligent data includes at least one of:
human face detection data;
human shape detection data;
human face tracking data;
human shape tracking data; or
data relating to vehicle structures.

15. The surveillance method of claim 12, wherein the first target format or the second target format includes at least one of:
YUV;
RGB; or
YCbCr.

16. The surveillance method of claim 12, further comprising:
obtaining the first digital multimedia data.

17. The surveillance method of claim 12, further comprising:
receiving second analog multimedia data from the coaxial cable;
obtaining second digital multimedia data and second intelligent data by performing analog-digital conversion, decoding, and separation on the second analog multimedia data; and
converting the second digital multimedia data from a second initial format into at least one format and the second intelligent data from a third initial format into at least one format.

18. The surveillance method of claim 17, the converting the second digital multimedia data from a second initial format into at least one format and the second intelligent data from a third initial format into at least one format includes:
converting the second digital multimedia data from the second initial format into a third target format and the second intelligent data from the third initial format into a fourth target format; and
wherein the surveillance method further comprising:
encoding the second digital multimedia data of the third target format and the second intelligent data of the fourth target format.

19. The surveillance method of claim 17, the converting the second digital multimedia data from a second initial format into at least one format and the second intelligent data from a third initial format into at least one format includes:
converting the second digital multimedia data from the second initial format into a fifth target format and the second intelligent data from the third initial format into a sixth target format; and
wherein the surveillance method further comprising:
superimposing the second intelligent data of the sixth target format on the second digital multimedia data of the fifth target format for display.

20-26. (canceled)

27. A non-transitory computer readable medium, comprising at least one set of instructions, wherein when executed by at least one processor of one or more electronic device, the at least one set of instructions directs the at least one processor to:
converting first digital multimedia data from a first initial format into a first target format and a second target format;
obtaining first intelligent data based on the first digital multimedia data of the first target format;
generating first analog multimedia data by performing mixing, encoding and digital-analog conversion on the first digital multimedia data of the second target format and the first intelligent data; and
transmitting the first analog multimedia data via a coaxial cable.
